(19) United States
(12) Patent Application Publication
(10) Pub. No.: US 2026/0218802 A1
(43) Pub. Date: Jul. 30, 2026

(54) EXCESS FLOW VALVE DEVICE AND VALVE ASSEMBLY

(71) Applicant: JTEKT CORPORATION, Kariya-shi (JP)

(72) Inventors: Kazuki OKAMURA, Okazaki-shi (JP); Tetsuya TOKUNO, Kashihara-shi (JP); Natsuki IWAMOTO, Okazaki-shi (JP); Kazuhiro TAKABAYASHI, Okazaki-shi (JP); Toshikatsu KUBO, Obu-shi (JP); Kazushi NUMAZAKI, Toyota-shi (JP)

(73) Assignee: JTEKT CORPORATION, Kariya-shi (JP)

(21) Appl. No.: 19/143,261

(22) PCT Filed: Jan. 11, 2023
(86) PCT No.: PCT/JP2023/000353

§ 371 Date: Jun. 25, 2025

(51) Int. Cl. F16K 17/30; F17C 13/04

(52) U.S. Cl. CPC F16K 17/30; F17C 13/04; F17C 2205/0332; F17C 2205/0385

(57) ABSTRACT

An excess flow valve includes: a valve seat provided in a valve disc housing portion of a gas channel and having a valve orifice; a valve disc configured to be slidably housed in the valve disc housing portion; and a biasing member configured to bias the valve disc. The valve disc includes a head configured to close the valve orifice, and a protruding portion protruding from the head and configured to be inserted into the valve orifice. The travel range of the valve disc between open and closed positions includes a first transition range and a second transition range. The first transition range is a range in which the valve disc travels with the entire protruding portion located in the valve disc housing portion. The second transition range is a range in which the valve disc travels with at least part of the protruding portion located in the valve orifice.

### TECHNICAL FIELD

The present disclosure relates to excess flow valve devices and valve assemblies.

### BACKGROUND ART

For example, Patent Document 1 discloses a valve assembly for controlling the flow of gas. Such a valve assembly is mounted on, for example, a gas tank of a fuel cell electric vehicle to control the flow of hydrogen gas.

The valve assembly of Patent Document 1 includes a body having a gas channel, and a plurality of valve subassemblies attached to the body. The valve subassemblies include an excess flow valve that restricts the flow of the hydrogen gas such that the flow rate of the gas does not exceed a predetermined rate when the hydrogen gas is fed.

Such an excess flow valve includes a valve seat provided at an intermediate position in the gas channel, a valve disc slidably housed in the gas channel, and a spring that biases the valve disc in a direction away from the valve seat. The valve disc slides within the gas channel according to the force corresponding to the pressure difference between the upstream and downstream sides of the valve disc and the biasing force of the spring. For example, when there is no abnormality in a pipe connected to the excess flow valve and the pressure difference is within a normal range, the biasing force of the spring is larger than the force corresponding to the pressure difference. Therefore, under normal conditions, the valve disc separates from the valve seat, causing the excess flow valve to open. On the other hand, if the pressure difference becomes excessively large due to, for example, damage to the pipe, the force corresponding to the pressure difference becomes larger than the biasing force of the spring. As a result, under abnormal conditions, the valve disc is seated on the valve seat, causing the excess flow valve to close. The flow rate of the hydrogen gas is therefore less likely to exceed the predetermined rate.

### RELATED ART DOCUMENTS

### Patent Documents

Patent Document 1: Japanese Unexamined Patent Application Publication (Translation of PCT Application) No. 2015-523509 (JP 2015-523509 A)

### SUMMARY OF THE INVENTION

### Problem to be Solved by the Invention

It is desirable that an excess flow valve such as that described in Patent Document 1 can stably maintain its open state under normal circumstances and can quickly switch from the open state to the closed state when, for example, an abnormality occurs in a pipe.

### Means for Solving the Problem

An excess flow valve device according to an aspect of the present disclosure includes: a channel forming member including a gas channel; and an excess flow valve configured to restrict the flow of gas when the flow rate of the gas flowing through the gas channel in a predetermined direction exceeds a predetermined rate. The gas channel includes a valve disc housing portion that houses at least part of the excess flow valve. The excess flow valve includes: a valve seat provided in the valve disc housing portion and having a valve orifice; a valve disc configured to be slidably housed in the valve disc housing portion; and a biasing member configured to bias the valve disc in a direction away from the valve seat. The valve disc includes: a head configured to close the valve orifice when the head is seated on the valve seat; and a protruding portion protruding from the head and configured to be inserted into the valve orifice. The position where the valve disc is located farthest from the valve seat is an open position, and the position where the valve disc is seated on the valve seat is a closed position. The travel range of the valve disc between the open position and the closed position includes a first transition range and a second transition range. The first transition range is a range in which the valve disc travels with the protruding portion entirely located in the valve disc housing portion, and the second transition range is a range in which the valve disc travels with at least part of the protruding portion located in the valve orifice.

A valve assembly according to another aspect of the present disclosure includes: a body including a gas channel, the gas channel including a first channel and a second channel; and an excess flow valve configured to restrict the flow of gas when the flow rate of the gas flowing through the second channel in a predetermined direction exceeds a predetermined rate. The first channel is configured to be connected to a gas tank that stores the gas, and the second channel is configured to be selectively connected to any one of a plurality of external devices. The plurality of external devices includes a supply source of the gas to be charged into the gas tank, and a consumption device configured to consume the gas fed from the gas tank. The second channel includes a valve disc housing portion that houses at least part of the excess flow valve. The predetermined direction is a direction in which the gas is fed to the consumption device. The excess flow valve includes: a valve seat provided in the valve disc housing portion and having a valve orifice; a valve disc configured to be slidably housed in the valve disc housing portion; and a biasing member configured to bias the valve disc in a direction away from the valve seat. The valve disc includes: a head configured to close the valve orifice when the head is seated on the valve seat; and a protruding portion protruding from the head and configured to be inserted into the valve orifice. The position where the valve disc is located farthest from the valve seat is an open position, and the position where the valve disc is seated on the valve seat is a closed position. The travel range of the valve disc between the open position and the closed position includes a first transition range and a second transition range. The first transition range is a range in which the valve disc travels with the protruding portion entirely located in the valve disc housing portion, and the second transition range is a range in which the valve disc travels with at least part of the protruding portion located in the valve orifice.

### BRIEF DESCRIPTION OF THE DRAWINGS

FIG. 1 is a sectional view showing a schematic configuration of a valve assembly according to an embodiment.

FIG. 2 is an enlarged sectional view of the region near an excess flow valve in the valve assembly of FIG. 1, showing an enlarged section when a valve disc of the excess flow valve is in an open position.

FIG. 3 is a perspective view of the valve disc of the excess flow valve in FIG. 2 as viewed from a first side.

FIG. 4 is a perspective view of the valve disc of the excess flow valve in FIG. 2 as viewed from a second side.

FIG. 5 is an enlarged sectional view of the region near the excess flow valve in FIG. 2 when the valve disc of the excess flow valve is in a first transition range.

FIG. 6 is an enlarged sectional view of the region near the excess flow valve in FIG. 2 when the valve disc of the excess flow valve is in a second transition range.

FIG. 7 is an enlarged sectional view of the region near the excess flow valve in FIG. 2 when the valve disc of the excess flow valve is in a closed position.

### MODES FOR CARRYING OUT THE INVENTION

Hereinafter, an embodiment of an excess flow valve device and a valve assembly will be described with reference to the drawings.

The term “annular” as used in the present specification refers to the shape of any object that may be considered as annular as a whole, including a plurality of components or parts combined to form an annular shape, and an object with a notch etc. in part such as a C-shaped object. The “annular” shape includes, but is not limited to, a circular shape, an elliptical shape, and a polygonal shape with sharp or rounded corners, when viewed in the axial direction.

### Overall Configuration

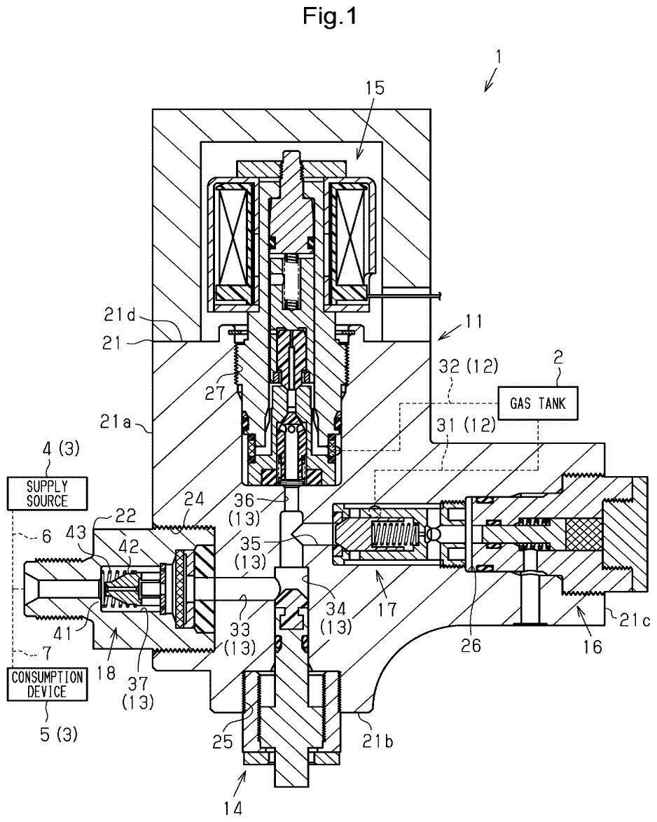

A valve assembly 1 illustrated in FIG. 1 is mounted to, for example, a gas tank 2 of a fuel cell electric vehicle. The gas tank 2 stores hydrogen gas at a high pressure of, for example, about 72.5 MPa. The valve assembly 1 is selectively connected to any one of a plurality of external devices 3. The plurality of external devices 3 includes a supply source 4 of hydrogen gas to be charged into the gas tank 2, and a consumption device 5 that consumes the hydrogen gas fed from the gas tank 2. The supply source 4 is, for example, a hydrogen station, and is connected to the valve assembly 1 via a pipe 6. The consumption device 5 is, for example, a fuel cell mounted on an automobile, and is connected to the valve assembly 1 via a pipe 7. The valve assembly 1 controls the flows of hydrogen gas to be charged into the gas tank 2 and hydrogen gas fed from the gas tank 2.

The valve assembly 1 includes a body 11 having a gas channel, and a plurality of valve subassemblies attached to the body 11. The gas channel includes a first channel 12 connected to the gas tank 2, and a second channel 13 connected to the external device 3. The plurality of valve subassemblies includes, for example, a manual valve 14, a composite valve 15, a safety valve 16, a check valve 17, and an excess flow valve 18. The plurality of valve subassemblies may include any valve subassembly in addition to or instead of these valve subassemblies.

### Body

The body 11 includes a main body 21 and a joint 22. The main body 21 is made of, for example, a metal material. The main body 21 has, for example, a rectangular parallelepiped shape that protrudes in part. The outer surface of the main body 21 includes a first side surface 21a, a second side surface 21b, a third side surface 21c, and a fourth side surface 21d. The first side surface 21a and the third side surface 21c are, for example, parallel to each other. The second side surface 21b and the fourth side surface 21d are, for example, parallel to each other. The first side surface 21a and the third side surface 21c are, for example, perpendicular to the second side surface 21b and the fourth side surface 21d.

The main body 21 has a plurality of attachment holes for members to be attached to the main body 21. The plurality of attachment holes includes, for example, a joint attachment hole 24 for attaching the joint 22, a manual valve attachment hole 25 for attaching the manual valve 14, an integrated attachment hole 26 for attaching the safety valve 16 and the check valve 17, and a composite valve attachment hole 27 for attaching the composite valve 15. The joint attachment hole 24 is, for example, a round hole, and is open to the first side surface 21a. The manual valve attachment hole 25 is, for example, a round hole, and is open to the second side surface 21b. The integrated attachment hole 26 is, for example, a round hole, and is open to the third side surface 21c. The composite valve attachment hole 27 is, for example, a round hole, and is open to the fourth side surface 21d.

The first channel 12 includes a charging portion 31 that allows the integrated attachment hole 26 to communicate with the gas tank 2, and a feeding portion 32 that allows the composite valve attachment hole 27 to communicate with the gas tank 2. The charging portion 31 is open to, for example, the inner peripheral surface of the integrated attachment hole 26. The safety valve 16 and the check valve 17 are thus connected to the gas tank 2 via the charging portion 31. The feeding portion 32 is open to, for example, the inner peripheral surface of the composite valve attachment hole 27. The composite valve 15 is thus connected to the gas tank 2 via the feeding portion 32. As illustrated in the figure, the charging portion 31 and the feeding portion 32 may be channels independent of each other.

The second channel 13 includes a first portion 33, a second portion 34, a third portion 35, a fourth portion 36, and a joint channel 37. The first portion 33, the second portion 34, the third portion 35, and the fourth portion 36 are provided in the main body 21. The joint channel 37 is provided in the joint 22 as will be described later.

The first portion 33 is open to the bottom surface of the joint attachment hole 24. The second portion 34 is open to the bottom surface of the manual valve attachment hole 25. The first portion 33 and the second portion 34 extend, for example, linearly. The second portion 34 is perpendicular to the first portion 33. The inner diameter of a part of the second portion 34 located inward of the intersection position between the second portion 34 and the first portion 33 is smaller than the inner diameter of a part of the second portion 34 located outward of the intersection position. The third portion 35 is open to, for example, the bottom surface of the integrated attachment hole 26. The third portion 35 allows the second portion 34 to communicate with the integrated attachment hole 26. The fourth portion 36 is open to, for example, the bottom surface of the composite valve attachment hole 27. The fourth portion 36 allows the second portion 34 to communicate with the composite valve attachment hole 27. The third portion 35 and the fourth portion 36 extend, for example, linearly.

As illustrated in the figure, the third portion 35 is perpendicular to, for example, the small diameter part of the second portion 34. The fourth portion 36 is provided, for example, coaxially with the second portion 34. The configuration of the second channel 13 is not limited to the example illustrated in the figure, and can be modified as appropriate. For example, the third portion 35 may be perpendicular to the large diameter part of the second portion 34 so as to be disposed coaxially with the first portion 33. The fourth portion 36 may be perpendicular to, for example, the second portion 34.

The joint 22 is made of, for example, a metal material. The joint 22 has, for example, a cylindrical shape. The joint 22 has the joint channel 37 that is a gas channel. The joint channel 37 extends linearly along, for example, the axial direction of the joint 22 and is open to both end faces of the joint 22. The joint 22 is fixed to the joint attachment hole 24 by any fixing method such as screw fastening or press fitting. The joint channel 37 thus communicates with the first portion 33. One of the pipes 6, 7 is connected to the joint 22. The supply source 4 or the consumption device 5 is thus connected to the second channel 13. The excess flow valve 18 is provided in the joint channel 37. That is, the joint 22 corresponds to the channel forming member, and the assembly formed by the joint 22 and the excess flow valve 18 corresponds to the excess flow valve device. Accordingly, the valve assembly 1 includes the excess flow valve device.

### Plurality of Valve Subassemblies

The manual valve 14 is fixed to the manual valve attachment hole 25 by any fixing method such as screw fastening or press fitting. The manual valve 14 is configured to close the second portion 34 of the second channel 13 through a user's operation.

The safety valve 16 is configured to close when the temperature of the safety valve 16 is equal to or lower than a threshold temperature. When in the closed state, the safety valve 16 does not release the hydrogen gas from the gas tank 2 to the outside. When the temperature of the safety valve 16 exceeds the threshold temperature, the safety valve 16 irreversibly changes from the closed state to the open state. When in the open state, the safety valve 16 releases the hydrogen gas from the gas tank 2 to the outside. The threshold temperature is preset such that the pressure of the hydrogen gas in the gas tank 2 does not become excessive and damage the gas tank 2.

The check valve 17 is configured to prevent backflow of the hydrogen gas charged into the gas tank 2. Specifically, the check valve 17 restricts the flow of the hydrogen gas from the charging portion 31 of the first channel 12 to the third portion 35 of the second channel 13 and allows the flow of the hydrogen gas from the third portion 35 to the charging portion 31.

The composite valve 15 includes a solenoid valve portion that serves as a solenoid valve, and a check valve portion that serves as a check valve. The composite valve 15 controls the flow of the hydrogen gas between the feeding portion 32 of the first channel 12 and the fourth portion 36 of the second channel 13 by opening and closing the solenoid valve portion. The check valve portion allows the flow of the hydrogen gas from the feeding portion 32 to the fourth portion 36 and restricts the flow of the hydrogen gas from the fourth portion 36 to the feeding portion 32. The high-pressure hydrogen gas is therefore less likely to act on the solenoid valve portion when the hydrogen gas is charged from the supply source 4 into the gas tank 2.

The excess flow valve 18 is configured to restrict the flow of the hydrogen gas when the flow rate of the hydrogen gas flowing through the joint channel 37 (second channel 13) in a predetermined direction exceeds a predetermined rate. The predetermined direction is, for example, a direction in which the hydrogen gas is fed from the gas tank 2 to the consumption device 5. The excess flow valve 18 does not limit the flow rate of the hydrogen gas in the opposite direction to the predetermined direction, that is, a direction in which the hydrogen gas is charged from the supply source 4 into the gas tank 2. The excess flow valve 18 will be described in detail later.

### Operation of Valve Assembly

When the hydrogen gas is to be charged into the gas tank 2, the supply source 4 is connected to the joint 22 via the pipe 6. When the hydrogen gas is supplied from the supply source 4, the hydrogen gas flows into the check valve 17 via the joint channel 37, the first portion 33, the second portion 34, and the third portion 35 of the second channel 13. Since the check valve 17 is configured to allow the flow of the hydrogen gas from the third portion 35 to the charging portion 31 as described above, the check valve 17 opens. The hydrogen gas is thus charged into the gas tank 2 via the charging portion 31. At this time, the hydrogen gas also flows into the check valve portion of the composite valve 15 via the second portion 34 to the fourth portion 36 of the second channel 13. However, since the check valve portion is configured to restrict the flow of the hydrogen gas from the fourth portion 36 to the feeding portion 32, the check valve portion closes. The hydrogen gas therefore does not flow from the second channel 13 into the feeding portion 32.

When the hydrogen gas is to be fed to the consumption device 5, the consumption device 5 is connected to the joint 22 via the pipe 7. The hydrogen gas in the gas tank 2 flows into the composite valve 15 via the feeding portion 32 of the first channel 12. When the solenoid valve portion of the composite valve 15 is controlled to open, the hydrogen gas flows into the check valve portion. Since the check valve portion is configured to allow the flow of the hydrogen gas from the feeding portion 32 to the fourth portion 36, the check valve portion opens. The hydrogen gas thus flows into the fourth portion 36, the second portion 34, the first portion 33, and the joint channel 37 of the second channel 13, and is fed to the consumption device 5 via the pipe 7. At this time, the hydrogen gas also flows into the check valve 17 via the second portion 34 to the third portion 35 of the second channel 13. However, since the check valve 17 is configured to restrict the flow of the hydrogen gas from the charging portion 31 to the third portion 35, the check valve 17 closes. The hydrogen gas therefore does not flow from the third portion 35 into the charging portion 31.

In this way, the second channel 13 is used as a hydrogen gas charging path and a hydrogen gas supply path. In other words, part of the hydrogen gas charging path and part of the hydrogen gas supply path are shared.

### Excess Flow Valve Device

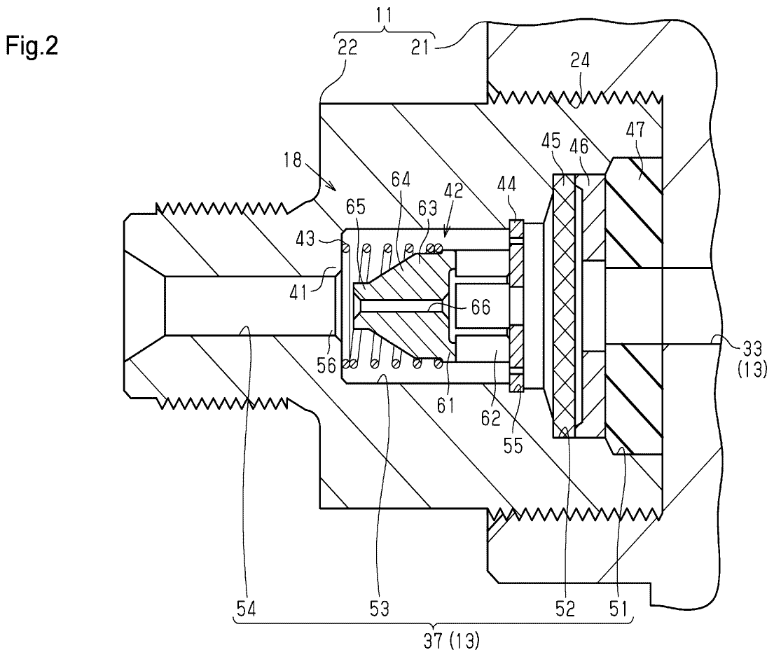

As illustrated in FIG. 2, the excess flow valve 18 is provided in the joint channel 37 of the joint 22. The excess flow valve 18 includes a valve seat 41 provided at an intermediate position in the joint channel 37, a valve disc 42 slidably housed in the joint channel 37, and a biasing member 43 that biases the valve disc 42 in a direction away from the valve seat 41. As illustrated in the figure, the excess flow valve 18 may include a stopper 44 that defines the travel range of the valve disc 42. The excess flow valve 18 may include a filter 45 and a retaining member 46 regardless of whether the excess flow valve 18 includes the stopper 44. The excess flow valve 18 may further include a seal member 47 regardless of whether the excess flow valve 18 includes the stopper 44 and regardless of whether the excess flow valve 18 includes the filter 45 and the retaining member 46. In the following description, the side of the joint channel 37 that is connected to the first portion 33 of the second channel 13 will be referred to as the first side, and the opposite side, i.e., the side of the joint channel 37 that is connected to the pipe 7, will be referred to as the second side.

For example, as illustrated in the figure, the joint channel 37 is linear along the axial direction of the joint 22. The joint channel 37 in the present embodiment has a stepped shape, with its inner diameter decreasing in a stepwise manner from the first side toward the second side. Specifically, the joint channel 37 includes a seal member housing portion 51, a filter housing portion 52, a valve disc housing portion 53, and a small diameter channel portion 54 in this order from the first side. The inner diameter of the joint channel 37 decreases in the order of the seal member housing portion 51, the filter housing portion 52, the valve disc housing portion 53, and the small diameter channel portion 54. An engagement groove 55 extending in a circumferential direction is provided at the end on the first side of the inner peripheral surface of the valve disc housing portion 53. The step portion between the valve disc housing portion 53 and the small diameter channel portion 54 is used as the valve seat 41 on which the valve disc 42 is seated. The end on the first side of the small diameter channel portion 54 is used as a valve orifice 56. That is, a portion of the joint 22 that is seamlessly continuous with the remaining portion thereof forms the valve seat 41. In other words, the joint 22 is a one-piece member that includes the valve seat 41 together with the joint channel 37. As illustrated in the figure, the inner peripheral edge of the valve seat 41 may be chamfered in a tapered fashion. The axial length of the small diameter channel portion 54 is set to be substantially equal to the axial length of the valve disc housing portion 53. In other embodiments, the axial length of the small diameter channel portion 54 may be set to be smaller or greater than the axial length of the valve disc housing portion 53.

The seal member 47 is made of, for example, a rubber material or a resin material. The seal member 47 has an annular shape. In the present embodiment, the seal member 47 has a circular shape when viewed in the axial direction. The seal member 47 is fitted in the seal member housing portion 51. Since the joint 22 is attached to the joint attachment hole 24, the seal member 47 is in close contact with the bottom surface of the joint attachment hole 24. This provides a seal between the main body 21 and the joint 22.

The filter 45 is made of, for example, wire mesh etc. The filter 45 has, for example, a circular shape when viewed in the axial direction. The retaining member 46 is made of, for example, a metal material. The retaining member 46 has an annular shape. In the present embodiment, the retaining member 46 has a circular shape when viewed in the axial direction. The filter 45 is disposed in the filter housing portion 52. The filter 45 is held from the first side by the retaining member 46 fitted in the filter housing portion 52. The filter 45 is thus fixed inside the filter housing portion 52.

The stopper 44 is made of, for example, a metal material. The stopper 44 has an annular shape. In the present embodiment, the stopper 44 has a C-shape when viewed in the axial direction. The stopper 44 is, for example, a snap ring. The stopper 44 is engaged with the engagement groove 55 of the valve disc housing portion 53. The stopper 44 is thus fixed inside the valve disc housing portion 53.

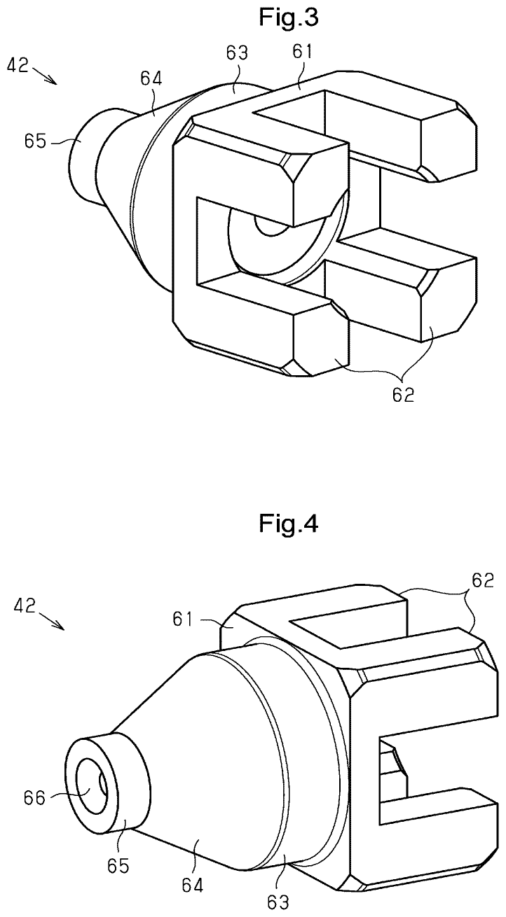

As illustrated in FIGS. 2, 3 and 4, the valve disc 42 is a poppet having a generally columnar shape. The valve disc 42 is housed in the valve disc housing portion 53 such that the axial direction of the valve disc 42 aligns with the longitudinal direction of the joint channel 37. The valve disc housing portion 53 is sometimes referred to as valve chamber. The valve disc 42 is made of, for example, a metal material. The valve disc 42 includes a base 61, a plurality of legs 62 that is continuous with the first side of the base 61, a mounting portion 63 that is continuous with the second side of the base 61, a head 64 that is continuous with the second side of the mounting portion 63, and a protruding portion 65 that is continuous with the second side of the head 64.

More specifically, the base 61 is in the form of a quadrilateral plate. A leg 62 is provided at each corner of the base 61. That is, the valve disc 42 has four legs 62. Each of the legs 62 has the shape of a quadrilateral prism. A ridge portion of each leg 62 that corresponds to a corner of the base 61 may be chamfered as illustrated in the figures. The ridge portion is in slidable contact with the inner peripheral surface of the valve disc housing portion 53. The mounting portion 63 has, for example, a cylindrical shape. The outer diameter of the mounting portion 63 is set to be slightly smaller than the diameter of a circle inscribed in the base 61. The head 64 has a tapered shape, with its outer diameter gradually decreasing toward the second side. The protruding portion 65 has a cylindrical shape. The protruding portion 65 protrudes from the distal end of the head 64 towards the second side. The outer diameter of the protruding portion 65 is set to be smaller than the inner diameter of the small diameter channel portion 54, i.e., the inner diameter of the valve orifice 56. Therefore, the head 64 closes the valve orifice 56 when seated on the valve seat 41. With the head 64 seated on the valve seat 41, the protruding portion 65 is inserted into the valve orifice 56.

Moreover, the valve disc 42 of the present embodiment has a small hole 66 extending therethrough in the axial direction of the valve disc 42. The small hole 66 extends through the base 61, the head 64, and the protruding portion 65. The hydrogen gas is thus fed through the joint 22 even when the valve disc 42 is seated on the valve seat 41. In other words, the excess flow valve 18 is configured to allow the flow of the hydrogen gas via the excess flow valve 18 even when the valve disc 42 is seated on the valve seat 41, i.e., even when the excess flow valve 18 is in the closed state. The inner diameter of the small hole 66 is set to be smaller than the inner diameter of the small diameter channel portion 54. Therefore, the flow rate of the hydrogen gas when the excess flow valve 18 is in the closed state is smaller than the flow rate of the hydrogen gas when the excess flow valve 18 is in the open state.

The biasing member 43 is, for example, a coil spring. The biasing member 43 is mounted on the outer periphery of the mounting portion 63 and is compressed between the base 61 and the outer peripheral edge of the valve seat 41. The biasing member 43 thus constantly biases the valve disc 42 toward the first side, i.e., in the direction away from the valve seat 41.

The valve disc 42 receives a force corresponding to the pressure difference between the upstream and downstream sides of the valve disc 42 (hereinafter, this force will be referred to as differential pressure biasing force). Therefore, the valve disc 42 slides inside the joint channel 37 according to the differential pressure biasing force and the mechanical biasing force of the biasing member 43.

When the hydrogen gas is fed to the consumption device 5, the first side of the valve disc 42 is the upstream side, and the second side of the valve disc 42 is the downstream side. Therefore, the valve disc 42 receives the pressure on the upstream side by the side surface on the first side of the base 61 and the end faces of the legs 62, and is biased toward the downstream side (second side). The valve disc 42 also receives the pressure on the downstream side by the side surface on the second side of the base 61, the tapered surface of the head 64, and the end face of the protruding portion 65, and is biased toward the upstream side (first side). At this time, the channel cross-sectional area of the valve disc housing portion 53 is smaller in a portion where the base 61 of the valve disc 42 is disposed than in the remaining portion. Therefore, the pressure in the valve disc housing portion 53 is lower in the space on the second side of the base 61 than in the space on the first side of the base 61. Since the channel cross-sectional area of the valve orifice 56 is smaller than the channel cross-sectional area of the valve disc housing portion 53, the pressure in the valve orifice 56 is lower than the pressure in the valve disc housing portion 53. That is, the differential pressure biasing force that is applied when the hydrogen gas is fed to the consumption device 5 biases the valve disc 42 in a direction toward the valve seat 41 (downward).

The mechanical biasing force of the biasing member 43 is set to be larger than the differential pressure biasing force corresponding to the pressure difference when, for example, there is no abnormality in the pipe 7 connected to the excess flow valve 18 and the pressure difference is within a normal range. Therefore, the valve disc 42 separates from the valve seat 41, causing the excess flow valve 18 to open. At this time, the valve disc 42 is restricted from traveling further toward the first side as the legs 62 contact the stopper 44. This position of the valve disc 42 is the position where the valve disc 42 is located farthest from the valve seat 41, and is the open position of the valve disc 42. On the other hand, if the pressure on the downstream side suddenly drops due to, for example, damage to the pipe 7 and the pressure difference becomes excessively large, the differential pressure biasing force corresponding to the pressure difference becomes larger than the mechanical biasing force. As a result, the valve disc 42 slides toward the second side and is seated on the valve seat 41, causing the excess flow valve 18 to close. The position where the valve disc 42 is thus seated on the valve seat 41 is the closed position of the valve disc 42.

The excess flow valve 18 of the present embodiment is configured such that the travel range of the valve disc 42 between the open position and the closed position includes a first transition range and a second transition range. The first transition range is a range in which the valve disc 42 travels with the entire protruding portion 65 located in the valve disc housing portion 53. The second transition range is a range in which the valve disc 42 travels with at least part of the protruding portion 65 located in the valve orifice 56. In the present embodiment, the dimensions of the valve disc 42 are set such that the magnitude of the first transition range is substantially equal to the magnitude of the second transition range.

Specifically, the axial length of the valve disc 42 is set to be smaller than the axial length from the valve seat 41 to the stopper 44 in the valve disc housing portion 53. The axial length of the protruding portion 65 is set to such a length that the distal end of the protruding portion 65 is inserted into the valve orifice 56 when the axial distance between the head 64 and the valve seat 41 becomes substantially equal to the distance between the leg 62 and the stopper 44.

### Operation of Excess Flow Valve Device

How the excess flow valve device operates when the valve disc 42 travels from the open position to the closed position due to an abnormality occurring in the pipe 7 during feeding of the hydrogen gas will be described.

When the valve disc 42 is located in the open position or within the first transition range, the head 64 and the protruding portion 65 of the valve disc 42 are entirely located in the valve disc housing portion 53. Therefore, the differential pressure biasing force is determined by the pressure in the valve disc housing portion 53 alone. As described above, the pressure in the valve disc housing portion 53 is lower in the space on the second side than in the space on the first side. However, the pressure difference is relatively less likely to increase under normal conditions. In other words, the differential pressure biasing force, namely a force that biases the valve disc 42 in the direction toward the valve seat 41, is less likely to increase.

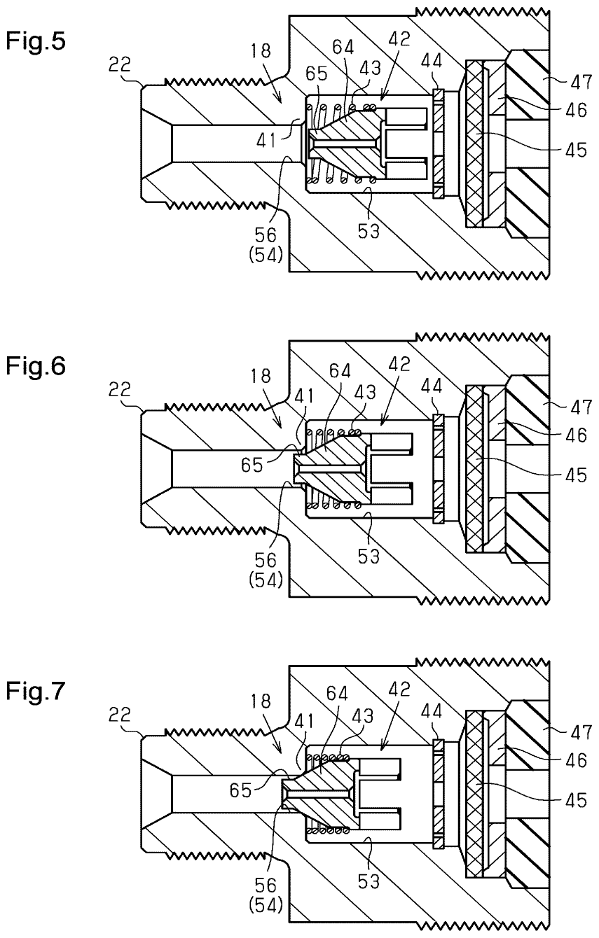

Therefore, as shown in FIG. 5, the valve disc 42 may slide slightly toward the second side due to, for example, fluctuations in pressure of the hydrogen gas being fed, but the valve disc 42 is less likely to slide beyond the first transition range toward the second side.

On the other hand, if the pressure in the pipe 7 suddenly drops due to an abnormality in the pipe 7 and the differential pressure biasing force increases, the valve disc 42 travels beyond the first transition range into the second transition range, as shown in FIG. 6. In this case, since the protruding portion 65 is inserted into the valve orifice 56, the protruding portion 65 is subjected to the pressure in the valve orifice 56 rather than the pressure in the valve disc housing portion 53. Therefore, in the second transition range, the differential pressure biasing force is determined by the pressure in the valve disc housing portion 53 and the pressure in the valve orifice 56. When the hydrogen gas is fed as described above, the pressure in the valve orifice 56 becomes lower than the pressure in the valve disc housing portion 53. Therefore, the pressure difference tends to increase. In other words, the differential pressure biasing force tends to increase.

Accordingly, when the valve disc 42 is located in the second transition range, the valve disc 42 tends to slide to the closed position. In particular, the more the valve disc 42 approaches the closed position, the smaller the space between the head 64 of the valve disc 42 and the valve seat 41 becomes, and therefore, the even lower the pressure in the valve orifice 56 becomes. Therefore, the differential pressure biasing force tends to increase even more. As a result, the valve disc 42 quickly travels toward the second side. As shown in FIG. 7, the valve disc 42 thus travels to the closed position, and the excess flow valve 18 closes.

Next, functions and effects of the present embodiment will be described.
(1) The travel range of the valve disc 42 includes the first transition range in which the differential pressure biasing force is less likely to increase, namely a range that is continuous from the open position toward the second side. Therefore, in order for the valve disc 42 to travel beyond the first transition range into the second transition range, the pressure difference between the upstream and downstream sides of the valve disc 42 needs to be sufficiently large. Therefore, the valve disc 42 is less likely to accidentally travel into the second transition range, and the open state of the valve disc 42 can be stably maintained under normal conditions. The travel range of the valve disc 42 also includes the second transition range in which the differential pressure biasing force tends to increase, namely a range that is continuous from the first transition range toward the second side. Therefore, after the pressure difference becomes sufficiently large due to an abnormality in the pipe 7 etc. and the valve disc 42 travels into the second transition range, the excess flow valve 18 can be quickly switched to the closed state.
(2) The magnitude of the first transition range is substantially equal to the magnitude of the second transition range. Therefore, the distance between the head 64 of the valve disc 42 and the valve seat 41 when the valve disc 42 is in the open position can be made larger than when the first transition range is smaller than the second transition range. This reduces an increase in pressure loss between the head 64 and the valve seat 41 during, for example, feeding of the hydrogen gas, and allows the hydrogen gas to be appropriately fed to the consumption device 5.
(3) The excess flow valve 18 is configured to allow the flow of the hydrogen gas via the excess flow valve 18 when the valve disc 42 is seated on the valve seat 41. This can reduce sudden leakage of the hydrogen gas of the gas tank 2 when, for example, such an abnormality occurs that the pipe 7 is damaged and the check valve 17 is stuck in the open position.

The present embodiment can be modified as follows. The present embodiment and the following modifications may be combined as appropriate as long as no technical inconsistency arises.
The valve disc 42 has the small hole 66. The excess flow valve 18 is thus configured to allow the hydrogen gas to be fed even when the excess flow valve 18 is in the closed state. However, the present disclosure is not limited to this. By, for example, forming a groove in either or both of the outer peripheral surface of the head 64 of the valve disc 42 and the inner peripheral surface of the valve orifice 56, the excess flow valve 18 may be configured to allow the hydrogen gas to be fed even when the excess flow valve 18 is in the closed state. Alternatively, the excess flow valve 18 may be configured not to allow the hydrogen gas to be fed when the excess flow valve 18 is in the closed state.
   The configuration of the valve disc 42 can be modified as appropriate. The shape and number of parts of the valve disc 42 may be modified. For example, the base 61 may be in the form of a disc, and the number of legs 62 may be changed. The valve disc 42 may have any configuration as long as it includes at least the head 64 and the protruding portion 65. For example, the valve disc 42 may not include the base 61, the legs 62, or the mounting portion 63.
   The magnitude of the first transition range may be set to be larger than the magnitude of the second transition range, or may be set to be smaller than the magnitude of the second transition range.
The stopper 44 is fixed inside the valve disc housing portion 53. However, the present disclosure is not limited to this, and the stopper 44 may be fixed outside the valve disc housing portion 53.
   In the excess flow valve 18, the filter 45 may be held by, for example, the seal member 47. In this case, the excess flow valve 18 may not include the retaining member 46 that is a separate member from the seal member 47. The excess flow valve 18 may not include the filter 45. The excess flow valve 18 may also not include the seal member 47
   The joint 22 is a one-piece member including the valve seat 41 together with the joint channel 37. However, the present disclosure is not limited to this, and a valve seat that is a separate member from the joint 22 may be fixed inside the joint channel 37. The configuration of the joint channel 37 can be modified as appropriate according to the configuration of the excess flow valve 18.
   The excess flow valve 18 may be incorporated into the main body 21 instead of being incorporated into the joint 22.
The excess flow valve device may be used independently of the valve assembly 1. In this case, the channel forming member forming the gas channel may be a member other than the joint 22.
   The valve assembly 1 controls the flow of the high-pressure hydrogen gas. However, the present disclosure is not limited to this. The valve assembly 1 may control the flow of a gas other than the hydrogen gas.
      Next, technical ideas that can be grasped from the above embodiment and modifications will be additionally described below.
(Appendix 1) The valve disc has a columnar shape and has a small hole extending therethrough in the axial direction of the valve disc. The small hole extends through the head and the protruding portion.
(Appendix 2) The excess flow valve includes a stopper that defines the open position of the valve disc.
(Appendix 3) The gas channel includes a small diameter channel portion continuous with the valve disc housing portion and having a smaller channel cross-sectional area than the valve disc housing portion. The step portion between the valve disc housing portion and the small diameter channel portion is used as the valve seat, and an end of the small diameter channel portion is used as the valve orifice.

1. An excess flow valve device including
a channel forming member including a gas channel, and
an excess flow valve configured to restrict flow of gas when a flow rate of the gas flowing through the gas channel in a predetermined direction exceeds a predetermined rate, wherein:
the gas channel includes a valve disc housing portion that houses at least part of the excess flow valve;
the excess flow valve includes
a valve seat provided in the valve disc housing portion and having a valve orifice,
a valve disc configured to be slidably housed in the valve disc housing portion, and
a biasing member configured to bias the valve disc in a direction away from the valve seat;
the valve disc includes
a head configured to close the valve orifice when the head is seated on the valve seat, and
a protruding portion protruding from the head and configured to be inserted into the valve orifice;
a position where the valve disc is located farthest from the valve seat is an open position, and a position where the valve disc is seated on the valve seat is a closed position;
a travel range of the valve disc between the open position and the closed position includes a first transition range and a second transition range;
the first transition range is a range in which the valve disc travels with the protruding portion entirely located in the valve disc housing portion; and
the second transition range is a range in which the valve disc travels with at least part of the protruding portion located in the valve orifice.

2. The excess flow valve device according to claim 1, wherein the first transition range is equal in magnitude to the second transition range.

3. The excess flow valve device according to claim 1, wherein the excess flow valve is configured to allow the flow of the gas via the excess flow valve when the valve disc is seated on the valve seat.

4. A valve assembly including
a body including a gas channel, the gas channel including a first channel and a second channel, and
an excess flow valve configured to restrict flow of gas when a flow rate of the gas flowing through the second channel in a predetermined direction exceeds a predetermined rate, wherein:
the first channel is configured to be connected to a gas tank that stores the gas;
the second channel is configured to be selectively connected to any one of a plurality of external devices;
the plurality of external devices includes a supply source of the gas to be charged into the gas tank, and a consumption device configured to consume the gas fed from the gas tank;
the second channel includes a valve disc housing portion that houses at least part of the excess flow valve;
the predetermined direction is a direction in which the gas is fed to the consumption device;
the excess flow valve includes
a valve seat provided in the valve disc housing portion and having a valve orifice,
a valve disc configured to be slidably housed in the valve disc housing portion, and
a biasing member configured to bias the valve disc in a direction away from the valve seat;
the valve disc includes
a head configured to close the valve orifice when the head is seated on the valve seat, and
a protruding portion protruding from the head and configured to be inserted into the valve orifice;
a position where the valve disc is located farthest from the valve seat is an open position, and a position where the valve disc is seated on the valve seat is a closed position;
a travel range of the valve disc between the open position and the closed position includes a first transition range and a second transition range;
the first transition range is a range in which the valve disc travels with the protruding portion entirely located in the valve disc housing portion; and
the second transition range is a range in which the valve disc travels with at least part of the protruding portion located in the valve orifice.
